(19) United States
(12) Patent Application Publication
(10) Pub. No.: US 2025/0381804 A1
(43) Pub. Date: Dec. 18, 2025

(54) CONTROL OF A VISIBLE LIGHT ARRAY TO DESCRIBE DEFECTS IN VEHICLE ROAD WHEEL

(71) Applicant: Toyota Research Institute, Inc., Los Altos, CA (US)

(72) Inventors: Andrea Michelle Rios Lazcano, Brussels (BE); Hiroshi Yasuda, San Carlos, CA (US)

(73) Assignees: Toyota Research Institute, Inc., Los Altos, CA (US); Toyota Jidosha Kabushiki Kaisha, Toyota-shi (JP)

(21) Appl. No.: 18/745,024

(22) Filed: Jun. 17, 2024

(51) Int. Cl. B60C 11/24; G01M 17/02

(52) U.S. Cl. CPC B60C 11/246; G01M 17/027

(57) ABSTRACT

A vehicle wheel defect indicator system includes a visible light array mounted on a vehicle wheel, a processor, and a memory communicably coupled to the processor and storing a light array control module. The light array control module includes computer-readable instructions that when executed by the processor cause the processor to, after a defect is detected in the vehicle wheel, determine a lighting scheme associated with the defect, and control operation of the visible light array to implement the lighting scheme. The visible light array may be attached to the vehicle wheel and is automatically controllable to implement the lighting scheme to communicate the wheel defect. This enables the nature of a detected wheel defect to be communicated to a user or other person without the need to couple an OBD (On-Board Diagnostics) scanner to a vehicle diagnostics port.

### TECHNICAL FIELD

The subject matter described herein relates to detection and description of defects in portions of motor vehicles and, more particularly, to an array of visible lights mountable on a vehicle road wheel and controllable to describe defects detected in the wheel.

### BACKGROUND

Typically, when a vehicle defect (i.e., a condition involving one or more components and/or systems of the vehicle and which may affect mechanical, electrical and/or other operations of the vehicle) is detected by a vehicle diagnostic system, a user of the vehicle may have little or no information regarding the nature of the defect until the vehicle can be communicably coupled to specialized, dedicated diagnostics equipment. for example, it may be necessary move the vehicle to a dealer or vehicle service facility where a suitable OBD (On-board Diagnostics) scanner can be plugged into a vehicle diagnostic port to access detailed defect information associated with a diagnostic trouble code (DTC) relating to the detected defect. Such diagnostic equipment may be expensive, difficult to use, and unavailable to the average vehicle user.

### SUMMARY

In one aspect of the embodiments described herein, a vehicle wheel defect indicator system is provided. The vehicle wheel defect indicator system includes a visible light array mounted on a vehicle wheel, a processor, and a memory communicably coupled to the processor and storing a light array control module. The light array control module includes computer-readable instructions that when executed by the processor cause the processor to, after a defect is detected in the vehicle wheel, determine a visible lighting scheme associated with the defect, and control operation of the visible light array to implement the visible lighting scheme.

In another aspect of the embodiments described herein, a method is provided for displaying information relating to a defect in a vehicle wheel. The method includes steps of determining that a defect exists in the vehicle wheel, determining a visible lighting scheme associated with the defect, and controlling operation of a visible light array to implement the lighting scheme.

In yet another aspect of the embodiments described herein, a non-transitory computer readable medium is provided. The non-transitory computer readable medium has stored therein instructions, that when executed by a computing system, cause the computing system to perform functions comprising determining that a defect exists in a vehicle wheel, determining a visible lighting scheme associated with the defect, and controlling operation of a visible light array to implement the lighting scheme.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 shows a block schematic diagram of a vehicle incorporating a vehicle wheel defect indicator system in accordance with embodiments described herein.

FIG. 1A is a block schematic diagram showing examples of some wheel-related sensors that may be incorporated into the sensor system.

FIG. 2 is an exploded view of one embodiment of a vehicle wheel incorporating an in-wheel motor.

FIG. 3 is a schematic plan view of one version of a visible light source arrangement in a lighting strip suitable for incorporation into a visible light array in accordance with an embodiment described herein.

FIG. 4 is a schematic side view of a vehicle wheel having mounted thereon an exemplary light array formed from multiple lighting strips as shown in FIG. 3.

FIG. 5 is a flow diagram illustrating operations of vehicle wheel defect indicator system in accordance with an embodiment described herein.

FIG. 6 illustrates one example of operation of the visible light array for determining an appropriate visible lighting scheme and communicating a defect associated with an in-wheel motor of a wheel on which a lighting strip is mounted.

FIG. 6A shows the light array of FIG. 4 being controlled to stroboscopically display information relating to a wheel defect.

FIG. 7 is the schematic side view of FIG. 4 illustrating detection of a foreign object in tire treads of a vehicle wheel by a radar sensor.

FIG. 8 is the schematic side view of FIG. 7 illustrating control of a visible light array applied to the vehicle wheel to indicate a portion of the tire tread containing the foreign object.

### DETAILED DESCRIPTION

Embodiments described herein relate to of the vehicle wheel defect indicator system described herein may be configured to provide a visible indication of the nature of a defect detected in a road wheel of a vehicle. The vehicle wheel defect indicator system employs a visible light array that may be attached to the vehicle wheel. The vehicle wheel defect indicator system is automatically controllable to display a visible lighting scheme associated with a given wheel defect and a description of the defect. This enables the nature of a detected wheel defect to be communicated to a user or other person without the need to couple an OBD (On-Board Diagnostics) scanner to a vehicle diagnostics port, as required in conventional diagnostics systems.

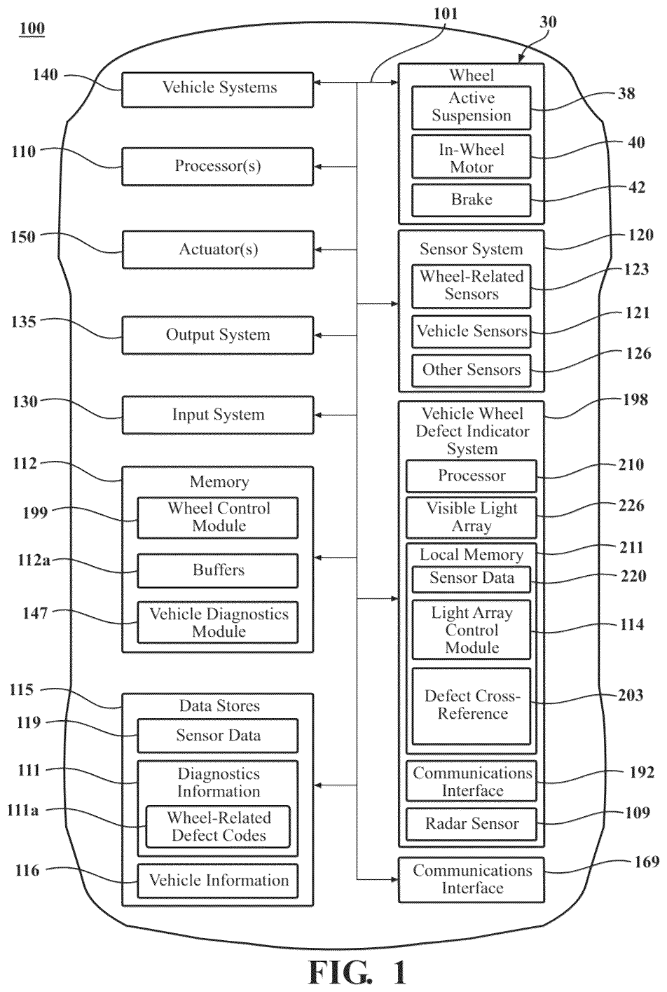

FIG. 1 shows a block schematic diagram of a vehicle 100 incorporating a vehicle wheel defect indicator system in accordance with embodiments described herein. Referring to FIG. 1, an example of a vehicle 100 is illustrated. As used herein, a “vehicle” is any form of motorized transport. In one or more implementations, the vehicle 100 is conventionally-powered, hybrid-electric powered, or fully-electric powered passenger vehicle. While arrangements will be described herein with respect to passenger vehicles, it will be understood that embodiments are not limited to passenger vehicles. In some implementations, the vehicle 100 may be any form of motorized transport that benefits from the functionality discussed herein.

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. One or more suitable communications bus(es) 101 may enable communication between the elements and systems of the vehicle 100.

Some of the possible elements of the vehicle 100 are shown in FIG. 1 and will be described with reference thereto. Additionally, it will be appreciated that for simplicity and clarity of illustration, where appropriate, reference numerals may have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

Referring to FIG. 1, the vehicle 100 can include various vehicle systems (collectively designated 140) usable to enable and/or facilitate operation of conventional motor vehicles. For example, the vehicle systems 140 can include a propulsion system, a braking system, a steering system, throttle system, a suspension system, a transmission system, and/or a navigation system, none of which are explicitly shown in FIG. 1. Each of these systems can include one or more devices, components, and/or a combination thereof, now known or later developed. Other vehicle systems may also be incorporated into the vehicle 100 where necessary for performing the functions described herein.

In one or more embodiments, the vehicle 100 is an over-actuated vehicle. For purposes described herein, an “over-actuated vehicle” is a vehicle in which each road wheel has independent propulsion/torque, steering, braking and/or other control capabilities. To impart these capabilities to the wheels, in some arrangements, each wheel may incorporate an in-wheel motor. Examples of particular capabilities of an over-actuated vehicle that utilizes in-wheel motors include switching between front/rear/all-wheel drive modes and torque vectoring capability, which enables separate adjustment of the torque exerted by each individual wheel to control the vehicle more precisely in extreme conditions or when turning. As is known, because of the complexity of over-actuated vehicles, these vehicles are typically controlled using steer-by-wire systems.

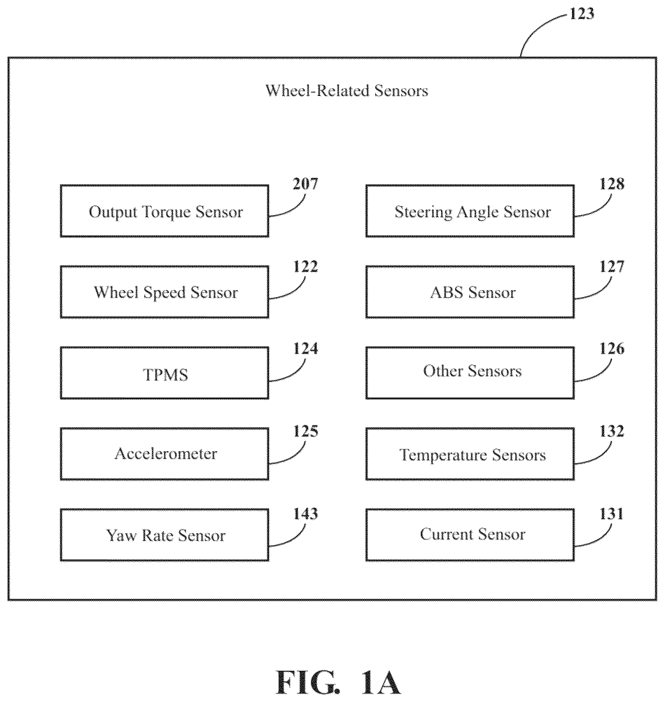

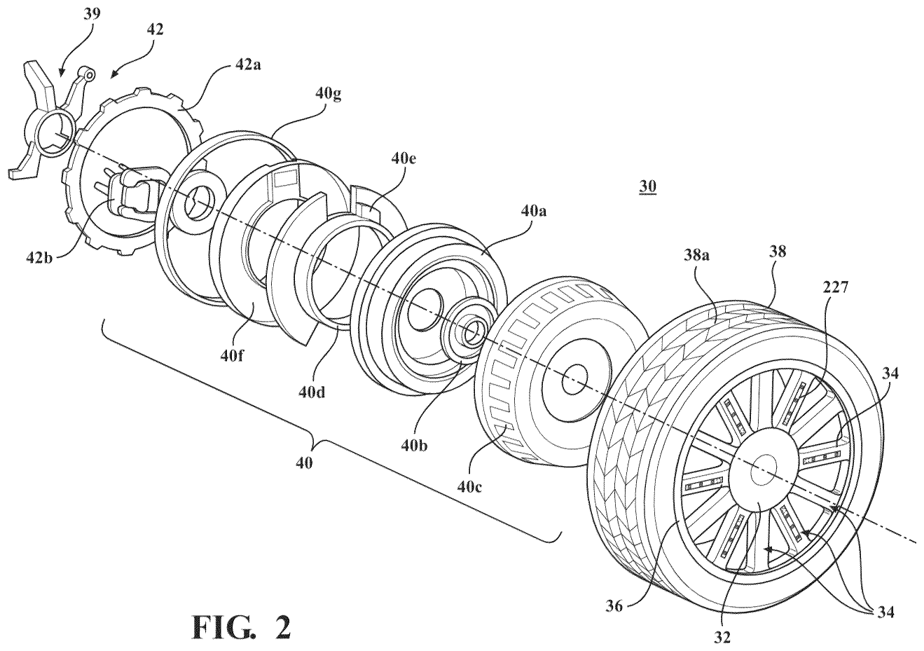

The vehicle 100 may include at least one wheel(s) 30 operatively connected to a frame of the vehicle 100 and configured for supporting and propelling the vehicle. referring to FIG. 2, in one or more arrangements, each wheel 30 may include a hub 32, a continuous rim 36 radially spaced-apart from the hub 32, and a plurality of angularly spaced-apart spokes 34 extending between (and connecting) the hub 32 and the rim 36. A tire 38 having an exterior tread 38a may be mounted along a radially-exterior portion of the rim for supporting the vehicle on a road surface.

The term “operatively connected,” as used throughout this description, can include direct or indirect connections, including connections without direct physical contact. In one or more arrangements, operative connection of elements and/or systems enables the connected elements/systems to interact with each other in some way, to perform and/or facilitate operations of the vehicle. For example, one or more connected elements/systems may assist one or more other connected elements/systems in performance one or more vehicle operations (for example, by generating or processing information for use by the one or more other connected elements/systems). One or more connected elements/systems may also combine with one or more connected elements/systems to perform and/or facilitate performance of one or more vehicle operations. Other effects of operative connection between vehicle elements and/or systems may be realized.

FIG. 2 is an exploded view of one embodiment of a vehicle wheel 30 incorporating an in-wheel motor. Referring to FIG. 2, in one or more arrangements of the vehicle 100, each wheel 30 may incorporate an in-wheel motor (generally designated 40) positioned inside and extending from a cavity formed in the wheel hub 32. As known in the pertinent field, in some examples, the in-wheel motor 40 may include a rotor 40a, a bearing 40b, a stator 40c, a capacitor ring 40d, a supporting frame 40f, and a seal ring 40g. A motor controller 40e may be operatively connected to the other motor components for localized control of the motor 40 responsive to motor control commands received from a wheel control module 199 (FIG. 1) of the vehicle 100. In some arrangements, the motor controller 40e may incorporate a communications interface (not shown) to enable receipt of motor control commands from (and transmission of data or other feedback to) the wheel control module 199. As known in the pertinent field, capabilities of a vehicle incorporating in-wheel motors in the road wheels may include switching between front/rear/all-wheel drive and torque vectoring, which includes adjusting the torque of each individual tires separately to control the vehicle more precisely in extreme conditions or when turning.

In one or more arrangements, the wheel 30 may also incorporate an individually controllable wheel brake 42 including brake disk 42a and a brake caliper 42b, usable for braking the individual wheel 30 responsive to a wheel control command from the wheel control module 199. The wheel 30 may also incorporate an active suspension 39 configured to be individually controllable responsive to a wheel control command the wheel control module 199.

The vehicle 100 can include one or more processor(s) 110. In one or more arrangements, the processor(s) 110 can be a main processor(s) of the vehicle 100. For instance, the processor(s) 110 can be an electronic control unit (ECU). The vehicle 100 can include one or more data stores 115 for storing one or more types of data. The data store(s) 115 can include volatile and/or non-volatile memory. Examples of suitable data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 115 can be a component of the processor(s) 110, or the data store(s) 115 can be operatively connected to the processor(s) 110 for use thereby.

The one or more data store(s) 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more wheel-related sensors 123 of the vehicle sensor system 120.

The one or more data store(s) 115 can include vehicle information 116. The vehicle information 116 can include any information relating to the vehicle 100 which enables and/or facilitates operation of the sensor system 120, the actuators 150, the communications interface 169, and/or any component and system of the vehicle 100 in performance of any of the functions and operations described herein.

The one or more data store(s) 115 can include diagnostics information 111. Diagnostics information 111 can include any data and/or other information enabling and/or facilitating processing of sensor data and other information for purposes of determining the presence and/or likelihood of defects in the vehicle (including defects in the vehicle wheels). In one or more arrangements, the diagnostics information 111 can include wheel-related defect or trouble codes 111a. The wheel-related defect codes 111a can include codes associated with existing or potential defects or operating problems with the in-wheel motor 40 incorporated into the wheel 30. In particular arrangements, the wheel-related defect codes can include (or be in the form of) conventional diagnostic trouble codes (DTC's).

The vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor(s) to keep up with some external process.

In arrangements in which the sensor system 120 includes a plurality of sensors, the sensors can work independently from each other. Alternatively, two or more of the sensors can work in combination with each other. In such cases, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1).

The sensor system 120 can include any suitable type of sensor. Various examples of different types of sensors are described herein. However, it will be understood that the embodiments are not limited to the particular sensors described or to the particular sensors shown in FIG. 1. The sensor system 120 may include any sensors suitable for and/or required to perform any of the data acquisition and/or vehicle control operations contemplated herein. Sensors of sensor system 120 may be communicably coupled to the various systems and components of the vehicle 100. The sensors may be operatively connected to the vehicle communications interface 169 for transmission of information to a cloud or other storage facility. The sensors may also be operatively connected to other vehicle systems and components, such as data stores 115 and processor(s) 110, for storage and processing of wheel-related and other vehicle sensor data. Sensor system 120 may include sensors configured to detect the current state or status of vehicle systems and components and to generate indications (for example, using trouble codes) of possible malfunctions of vehicle systems and components.

The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system, and/or other suitable sensors. The vehicle sensor(s) 121 can be configured to detect, and/or sense one or more characteristics of the vehicle 100, such as the current geographical location of the vehicle. In one or more arrangements, the vehicle sensor(s) 121 can include a speedometer to determine a current speed and acceleration/deceleration of the vehicle 100.

The sensor system 120 can include one or more wheel-related sensors 123. Wheel-related sensors are sensors capable measuring parameters pertinent to the health status and functioning of the elements of each road wheel (including the brake 42, the in-wheel motor 40, the suspension 39, the wheel motor controller 40e, and/or any other elements included in the wheel 30). In some arrangements, one or more elements of the wheel-related sensors 123 may be incorporated into the structure of the wheel. In some arrangements, one or more elements of the wheel-related sensors 123 may be mounted on another portion of the vehicle 100 separate from the wheel 30. In some arrangements, certain ones of wheel-related sensors 123 may perform functions of (and serve as) vehicle sensors 121 and/or certain ones of vehicle sensors 121 may perform functions of (and serve as) wheel-related sensors 123.

Examples of in-wheel motor defects which may cause failure of the motor 40 include motor winding open circuits and short circuits, failure of power regulation devices (e.g., inverters), capacitor failures, high impedance, impairment of magnetization and winding insulation due to excessively temperature conditions, motor bearing failure, mechanical failures due to static or dynamic eccentricity, and other defects. The wheel-related sensors 123 may include one or more sensors configured to detect defect conditions directly. The wheel-related sensors 123 may include sensors (or combinations of sensors) configured to provide sensor data to the vehicle diagnostics module 147 for processing. The vehicle diagnostics module 147 may be configured to process sensor data for one or more sensors to detect the presence of an existing wheel defect or determine conditions indicative of a developing wheel defect, including a defect in an in-wheel motor.

FIG. 1A is a block schematic diagram showing examples of some wheel-related sensors that may be incorporated into the sensor system 120. Wheel-related sensors 123 that may be incorporated into the sensor system 120 and which may be associated with each wheel 30 include a wheel speed sensor 122 configured to detect the speed and direction of rotation of the wheel and supply this information to the ABS (anti-lock braking system). The sensors 123 may include an ABS sensor 127 to facilitate operation of the brake 42 incorporated into the wheel 30. The sensors 123 may include a TPMS (Tire Pressure Monitoring System) 124 configured to monitor the air pressure in a tire of the wheel. The sensors 123 may include a current sensor 131 configured for detecting interrupted and insufficient current flow to the in-wheel motor. The sensors 123 may include a temperature sensor 132 for detecting an excessively high temperature condition in the wheel which may damage the motor. The sensors 123 may include an output torque sensor 207 for determining any torque offset (i.e., a difference between a torque command and the determined actual engine output torque, which may also be indicative of an excessively high temperature condition in the wheel). the sensors 123 may also include other sensors 126 as required (e.g., an accelerometer 125, a steering angle sensor 128, a yaw rate sensor 143, a rotor position sensor, sensors configured for detecting short circuits and open circuits in the motor, etc.) to perform and/or facilitate the vehicle operations described herein.

Controlling an operation of the vehicle 100 may include automatically controlling operation of some portion of the vehicle to perform a specific task or function. For example, in one or more arrangements, operation of the vehicle may be controlled by controlling operation of the output system 135 to generate an alert directed to a human user and configured to indicate a particular condition detected by the wheel-related sensors 123 and/or other vehicle sensors.

The vehicle communications interface 169 may be configured to enable and/or facilitate communication between the components and systems of the vehicle 100 and also with entities (such as cloud facilities, cellular and other mobile communications devices, other vehicles, etc.) exterior of the vehicle. The vehicle communications interface 169 may be configured to enable and/or facilitate communication between the vehicle processor 110 and elements of the vehicle wheel defect indicator system 198. In one or more arrangements, the vehicle communications interface 169 may be a wireless communications interface.

The vehicle 100 can include an input system 130. An “input system” includes any device, component, system, clement or arrangement or groups thereof that enable information/data to be entered into a machine. For example, the input system 130 may include a keypad, a touch screen or other interactive display, a voice-recognition system and/or any other device or system which facilitates communications between a user and the vehicle. The input system 130 can receive an input from a vehicle occupant (e.g., a driver or a passenger) or a user located remotely from the vehicle 100. In particular embodiments, the input system 130 may include buttons and/or switches enabling a user to stop or start the vehicle simply by actuating the buttons/switches. In one or more examples, the input system 130 may be configured to enable a user to command an embodiment of the vehicle wheel defect indicator system described herein to control operation a visible light array to communicate a visible lighting scheme associated with a defect code when a road wheel flagged as having an existing or possibly pending defect has stopped rotating. The defect code and the lighting scheme determined to be associated with the defect code may be stored in a memory 112 communicably coupled to the processor 110 which is, in turn, incorporated into or communicably coupled to the vehicle wheel defect indicator system 198.

For purposes described herein, a “visible light array” is group of visible light sources configured to perform the lighting and information display functions described herein. characteristics of a given visible light array include the total number of light sources applied to a vehicle wheel, the colors of individual light sources, the spatial arrangement of individual light sources relative to each other as applied to the wheel, the positions of individual light sources on the wheel, the sizes and brightnesses or power levels of the light sources, and other characteristics.

The vehicle 100 can also include an output system 135. An “output system” includes any device, component, or arrangement or groups thereof that enable information/data to be presented to a vehicle occupant (e.g., a driver, a vehicle passenger, etc.) or a remote user. In one or more examples, the output system 135 may include a cellular phone application configured to enable user interaction with the vehicle wheel defect indicator system 198. The application may enable receipt of messages and defect code descriptions and alerts, and may also enable a user to issue commands to the vehicle wheel defect indicator system 198.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the various module(s) described herein. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more of data store(s) 115 may contain such instructions.

Generally, a module, as used herein, includes routines, programs, objects, components, data structures, and so on that perform particular tasks or implement particular data types. In further aspects, a memory (such as memory 112) generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions. In one or more arrangements, module(s) described herein may be stored in a memory 112 communicably coupled to the processor(s) 110. The memory 112 may include buffers 112a for short-term storage.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 may include a vehicle diagnostics module 147. For purposes described herein, “vehicle diagnostics” may be defined as a process of examining a vehicle's systems and components to identify and repair any issues that may affect its normal operation. For example, in one or more arrangements, the vehicle diagnostics module 147 may include computer-readable instructions that when executed by the processor 110 cause the processor to receive sensor data from vehicle sensor system 120 (including wheel-related sensors 123) and also from other vehicle systems and/or components that configured to detect and/or determine information relevant to vehicle diagnostics.

The vehicle diagnostics module 147 may include computer-readable instructions that when executed by the processor 110 cause the processor to process received information to determine if any defects are present or have a high probability of occurring in the vehicle 100. The vehicle diagnostics module 147 may include computer-readable instructions that when executed by the processor 110 cause the processor to, based upon the received information, determine a defect code associate with the existing or highly probable defect. In particular arrangements, the defect code may be a diagnostic trouble code (DTC). As known in the field of vehicle diagnostics, each diagnostic trouble code may signify an associated existing or potential defect or operating problem with a component or system of a vehicle. The pertinent defect code may be stored in a memory 112 for later access using an OBD (On-Board Diagnostics) scanner in a conventional manner. the vehicle diagnostics module 147 may include computer-readable instructions that when executed by the processor 110 cause the processor to, responsive to a determination that a defect exists or has a high probability of occurring, generate an alert directed to a human user and configured to indicate the existence or probability (and, optionally, the nature) of the defect. The vehicle diagnostics module 147 may also be configured to perform other functions.

Vehicle embodiments incorporating one or more in-wheel motors may include a wheel control module 199 configured to coordinate control of the road wheels and their components. For example, in one or more arrangements, the wheel control module 199 may include computer-readable instructions that when executed by the processor 110 cause the processor to generate coordinated control commands to each road wheel responsive to driver instructions, sensor data and/or other relevant information. The commands may include commands to one or more of the in-wheel motors, braking commands, commands to the wheel active suspension and/or any other commands needed to effect a desired response of the vehicle.

Referring again to FIG. 1, the vehicle 100 may include a vehicle wheel defect indicator system (generally designated 198) in accordance with an embodiment described herein.

Generally, the vehicle wheel defect indicator system 198 may be configured to provide a visual indication of the presence and nature of an existing or highly probable defect in an associated vehicle road wheel.

In one or more arrangements, the vehicle wheel defect indicator system 198 may include a suitably-configured local memory 211 communicably coupled to a processor 210 and configured for storing data, modules and/or other software elements usable for operation of the vehicle wheel defect indicator system. The local memory 211 may be configured to store thereon sensor data 220 relating to a radar sensor 109 (described in greater detail below) incorporated into the vehicle wheel defect indicator system 198. The local memory 211 may be configured to store thereon a defect cross-reference 203 configured to store and provide associations between defect/trouble codes determined by the vehicle diagnostics module 147 and lighting schemes that may be displayed by a visible light array 226 (described in greater detail below) to indicate the presence and nature of an associated wheel defect (including a defect in an in-wheel motor) detected by wheel-related sensors 123, as described herein. The defect cross-reference 203 may also be configured to store thereon lighting schemes that may be displayed by the visible light array 226 to indicate the presence and location of a wheel defect in the form of a foreign object positioned in a tire tread of an associated vehicle wheel. In some arrangements, the defect cross-reference 203 may include suitably configured lookup tables associating each determinable wheel defect with a unique lighting scheme.

For purposes described herein, a “lighting scheme” is a plan for selectively activating (by control commands generated by an associated light array control module) one or more of the visible light sources in a given visible light array so as to represent or display a code and/or other information associated with a detected defect in a vehicle wheel. As described herein, in one or more arrangements, the information displayed may relate to a code (such as a diagnostic trouble code) associated with a particular wheel defect. In one or more arrangements, the information displayed may relate to a location of a foreign object positioned along an outer surface of a tire of the vehicle wheel. Display of other types of information is also possible. Each contemplated defect or failure mode of the vehicle wheel may have a unique lighting scheme associated therewith. The light array control module is configured to control the visible light array to implement (i.e., execute) a lighting scheme appropriate for a detected defect. Depending on the characteristics of the light sources in a given visible light array, a lighting scheme may specify parameters for controlling color selection of individual light sources (e.g., multi-color LED's), ON″ and “OFF” states of each light source (including an order in which light sources in an array are switched “ON” and “OFF” relative to each other, and a rate at which each light source flashes “ON” and “OFF”), and other operational aspects of the visible light array.

The vehicle wheel defect indicator system may include a one or more processor(s) 210 configured to execute instructions stored on the light array control module 114, and also to perform and/or facilitate other vehicle wheel defect indicator system functions as needed.

The vehicle wheel defect indicator system 198 may include a communications interface 192 configured for receiving signals and messages generated by the vehicle diagnostics module 147 and/or any element of the vehicle 100, including other elements of the vehicle wheel defect indicator system 198.

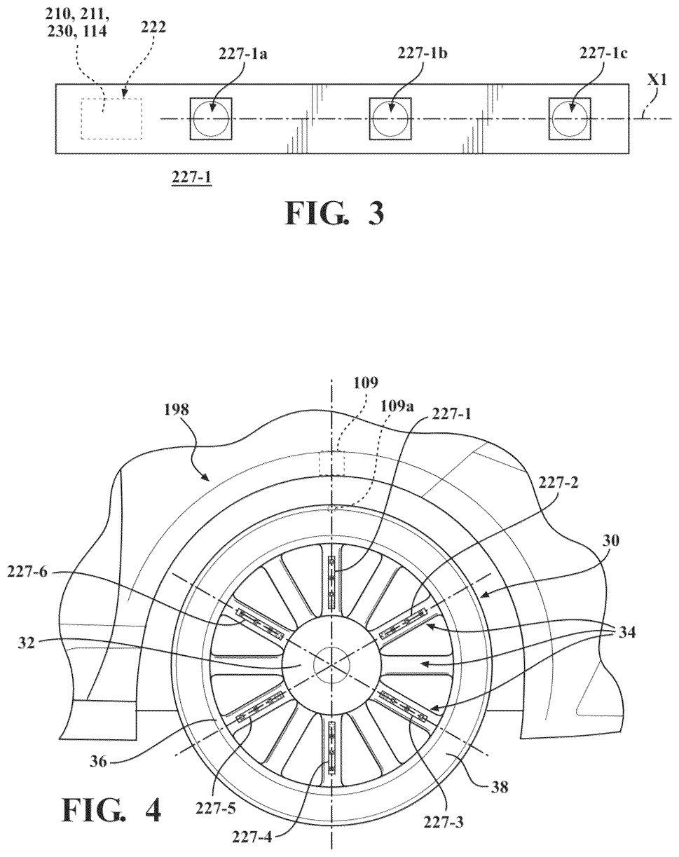

In one or more arrangements, the visible light array 226 may include at least one arrangement of visible light sources structured to be positionable along an associated road wheel. FIG. 3 is a schematic plan view of one version of a visible light source arrangement incorporated into a strip 227-1 suitable for incorporation into a visible light array in accordance with an embodiment described herein. The physical structure and emission options of the light source arrangement shown in FIG. 3 have been simplified for purposes of description. However, any of numerous variations in light source arrangement, number, and color options are possible according to the requirements of a particular application.

As seen in FIG. 3, the lighting strip 227-1 includes three light sources 227-1a, 227-1b, and 227-1c arranged collinearly on axis X1 extending along a length of a lighting strip. The light sources may be LED light sources. In one or more arrangements, the light sources may be labeled on the strip (e.g., “1”, “2”, “3”, etc.) for user reference in interpreting the meaning of a defect code as displayed by the lighting strip. The strip 227-1 may be configured for attachment to one of the wheel spokes as shown in FIG. 4 (or otherwise along an exterior side of the wheel), using adhesive attachment of another suitable application method.

In one or more arrangements the strip 227-1 may include a housing 222 for containing other elements of the vehicle wheel defect indicator system 198 (e.g., local memory 211, processor 210, a battery 230 for powering the light sources, etc.) in electrical communication with the light sources 227 and needed for controlling operation of the light sources to communicate wheel defect information. Other configurations (e.g., non-linear configurations) of the light sources may be employed. Also, any suitable number of light sources may be incorporated into the lighting strip.

In one simplified exemplary arrangement, each of the light sources 227-1a, 227-1b, and 227-1c may be capable of emitting light in any one of three different colors (e.g., red, green, and blue) when activated. Thus, since each light source may have any one of three activated colored states, the number of possible unique color combinations displayable by the lighting strip 227-1 is 3×3×3=27. Each color combination may be associated with a unique wheel defect (such as a trouble code or a particular location of a foreign object in the tire tread) relating to the associated vehicle wheel.

FIG. 4 is a schematic side view of a vehicle wheel having mounted thereon an exemplary light array formed from multiple lighting strips as shown in FIG. 3. The strips may be configured to extend conveniently along the wheel spokes 34. In the example shown in FIG. 4, each of lighting strips 227-1, 227-2, 227-3, 227-4, 227-5, and 227-6 is applied to an associated wheel spoke.as shown in FIG. 4, the lighting strips 227 may be applied to spokes that are equally angularly spaced-apart by a known amount (e.g., 60°). Each strip may be applied to a spoke so that the associated lighting strip housing 222 resides relatively closer to the wheel hub, with the collinear lighting arrangement of the strip extending radially outwardly in a direction from the wheel hub 32 toward the wheel tire.

The local memory 211 may be configured to store thereon a light array control module 114 of the vehicle wheel defect indicator system 198. In one or more arrangements, the light array control module may include computer-readable instructions that when executed by the processor cause the processor to, after a defect is detected in a vehicle wheel, determine a lighting scheme associated with the defect. In one or more particular arrangements, the lighting scheme is configured to relate to a defect in the in-wheel motor. In one or more particular arrangements, the lighting scheme is configured to relate to the presence of a foreign object positioned in a tread of a tire of the wheel. For purposes described herein, a “foreign object” is an object that has become embedded in the tire treads or otherwise attached to the tire by use of the tire during movement of the vehicle. Examples of foreign objects include bits of glass, pebbles, nails, and other objects that may be picked up by the tire from a road surface and/or which may cause damage to the tire treads.

In one or more arrangements, the light array control module 114 includes computer-readable instructions that when executed by the processor 210 cause the processor to control operation of the visible light array 226 to implement the lighting scheme. in one or more particular arrangements, the light array control module 114 includes computer-readable instructions that when executed by the processor 210 cause the processor to receive a diagnostic code associated with the defect, and determine a visible lighting scheme associated with the diagnostic code.

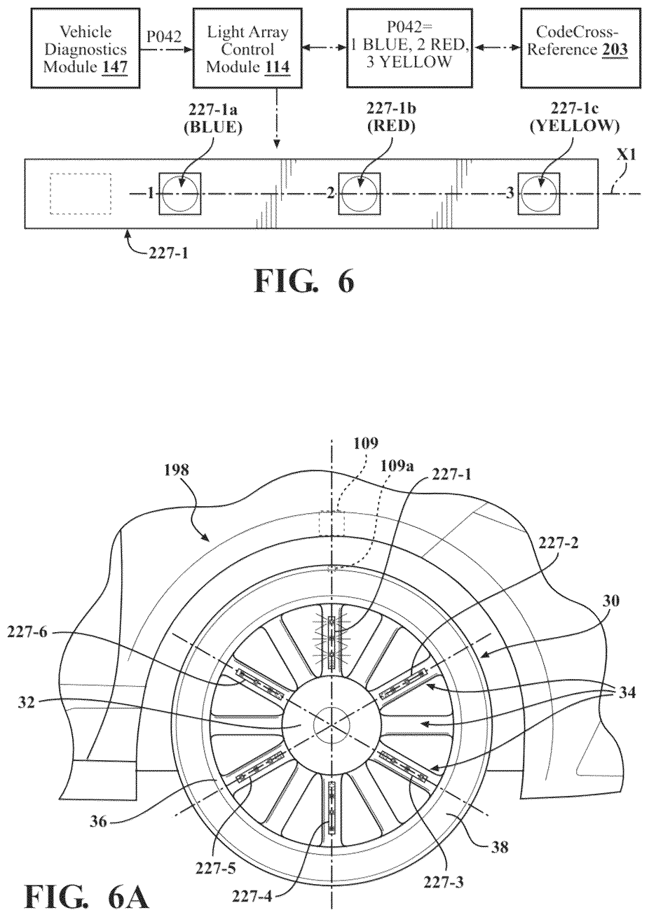

In particular aspects, for display of information relating to defects in an in-wheel motor, the light array control module includes computer-readable instructions that when executed by the processor cause the processor to control the visible light array so as to display the lighting scheme stroboscopically while the vehicle wheel is rotating. The stroboscopic effect is a well-known visual phenomenon in which a flashing speed of a light source is controlled to generate what appears to be a static image located on a rotating surface. For example, the light array control module 114 may receive wheel speed information from a sensor. If the vehicle wheel is rotating at 200 RPM, the light array control module 114 may control “ON” /“OFF” rates of appropriate visible light sources to flash “ON” for a short period of time at a rate (e.g., 200 times per minute) associated with the wheel rotational speed. Then, each flash of a light source occurs at the same position in its rotational cycle on the wheel, giving the appearance that the light and the wheel are stationary. The human eye and brain operate to smooth out the sequence of flashes so that the perceived image is continuous. This enables a user or a camera to view wheel defect information displayed by a rotating vehicle wheel. A lighting scheme is displayed stroboscopically when controlled by the light array control module in accordance with the wheel rotation speed, so that the lighting scheme display appears to be static on the wheel. FIG. 6A shows the light array of FIG. 4 being controlled to stroboscopically display information relating to a wheel defect.

In one or more arrangements, the visible light array 226 may include at least one collinear light arrangement mounted on an exterior of a side of the vehicle wheel. Referring to FIGS. 4-6, in one or more arrangements, the visible light array 226 comprises a plurality of angularly-spaced apart collinear light arrangements (in lighting strips 227-1 through 227-6) mounted on an exterior of a side of the vehicle wheel 30, each light arrangement extending along an associated line extending radially from a rotational axis of the vehicle wheel.

Referring to FIG. 4, for cases where the wheel defect is the presence of a foreign object in a tire tread of the vehicle wheel 30, the vehicle wheel defect indicator system 198 may include a wheel-related sensor(s) in the form of a radar sensor 109 mounted on the vehicle 100 spaced apart from the wheel 30 and configured to detect the radar reflective element 109a (described in greater detail below). In one or more arrangements, the radar sensor 109 may be a millimeter-wave (MMW or mm-wave) radar sensor(s) configured to scan treads of a tire of an associated vehicle wheel.

Millimeter-wave radar generally refers to a radar operating in the millimeter-wave band. Generally, the millimeter wave band is in the frequency domain of 30-300 GHZ (wavelength of 1-10 mm). In particular arrangements, a MMW radar sensor usable for the purposes described herein may operate within a frequency range of 60-GHz to 80-GHz inclusive. MMW radar is a radar technology which uses three-dimensional cloud point mapping and analysis to detect objects and object movements. For instance, MMW radar may be configured to detect an object that other types of sensors (for example, an ordinary camera) cannot because the radar can penetrate at least a portion of the material from which a tire is formed. A point cloud may be generated from the radar scan data using known methods. Object location, dimensional, and density data may be represented in distinguishable characteristics of each voxel in a point cloud. The density data may enable the radar to determine or estimate characteristics of an object such as a material from which the object is formed and also other characteristics.

The MMW radar sensor 109 may be configured to detect foreign objects lodged or otherwise positioned in or on the tire treads. Foreign objects meeting certain criteria (e.g., metallic objects, objects residing in or on the treads for at least an extended period of time, objects determined to have relatively sharp edges, etc.) may be classified as “defects” in the associated vehicle wheel, which may cause problems such as tire punctures, uneven tire wear and/or other problems with the wheel. If such a defect is detected, operation of the vehicle may be controlled by controlling the output system 135 to generate a “defect” alert directed to a human user to prompt investigation of the defect. The MMW radar sensor 109 may also be configured to detect characteristics such as shape, density, length, and/or width of a foreign object. Using values of these parameters, a degree of threat to normal operation of the wheel may be estimated.

The MMW radar sensor 109 may also be configured to detect a radar-reflective tire marker 109a intentionally attached to the tire in or on the treads. As described herein, the location of the tire marker 109a may serve as a reference location for determining the position of a detected foreign object relative to the tire marker. In particular configurations, the radar sensor 109 may operate as an imaging radar within the frequency range of 60-GHz to 80-GHz for purposes of scanning the tire tread when the tire is being rotated (i.e., during motion of the vehicle). A single sweep of the radar scanner may scan a predetermined area of the tire tread detectable in the field of vision of the radar sensor when the tire is rotating. A single sweep of the radar sensor and associated processing may produce a single frame of data. In one or more configurations, the radar sensor 109 may operate at about 20 frames/per second (i.e., 20 sweeps per second). Operating under these parameters, it is desirable to acquire data from multiple tire rotations to facilitate removal of anomalies from the data and provide a clear image. Thus, a “scan” may comprise enough sweeps to provide sufficient data to facilitate removal of anomalies from the data and provide a clear image. In one or more configurations, the maximum scanning rate is 5 sweeps per second.

In particular configurations, radar sensor power consumption may be between 170-280 mA per frame for active scanning at 20 sweeps/second at 12 volts DC, and 55 uA at a lowest scanning rate contemplated herein. The entire radar sensor assembly (including, for example, microcontroller associated circuitry and CAN-transceiver hardware) may be configured for operation at 12 volts DC. Peak RF sweep power may be around 4.6W. The MMW radar sensor 109 may be “trained” to recognize, with a high degree of accuracy and repeatability, various conditions relating to the tire treads. Training may be performed through programming, by repeated exposure to each condition, and/or by other known methods. In one or more arrangements, the radar sensor 109 may use an initial baseline scan of a clean, relatively new tire tread as a point of comparison against a previous or current radar scan to distinguish between separate added objects. Machine learning algorithms employing neural networks may also be used to teach the sensor to recognize and classify and track various foreign objects.

In one or more arrangements, the MMW radar sensor 109 may be mounted in a vehicle wheel well and may be configured to face toward the tread of an associated tire. The radar sensor 109 may be configured to detect the tire marker 109a positioned in the tire tread. The radar sensor 109 may also be configured to detect a foreign object 196 positioned in the tire tread. The MMW radar sensor 109 may be powered by an internal or associated battery or by a power source in the vehicle 100.

for cases where the wheel defect is the presence of a foreign object 196 in a tire tread of the vehicle wheel 30, the vehicle wheel defect indicator system 198 may also include the radar-reflective element or “tread marker” 109a attached to a location on the tire tread. Referring to FIG. 4, in some arrangements, the marker 109a may be attached to the tread so as to be positioned along a plane extending perpendicular to the plane of drawing FIG. 4 and through a central axis X1 of an associated one of the lighting strips 227-1, 227-2, 227-3, 227-4, 227-5, and 227-6 applied to the spokes 34. Then, the plane including the marker 109a and the spoke 34 with which the marker 109a is aligned may serve as a reference for identifying the location of a foreign object 196 positioned in the tire tread, as described herein.

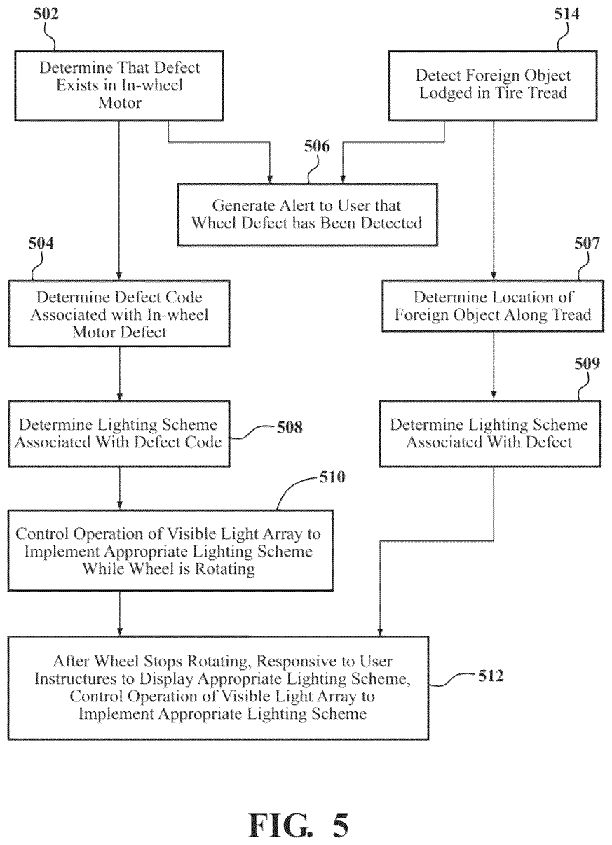

FIG. 5 is a flow diagram illustrating operations of vehicle wheel defect indicator system in accordance with an embodiment described herein. For situations where the wheel defect is a defect related to operation of the in-wheel motor or another internal portion of the wheel (such as brake 42 or active suspension 39), the vehicle wheel defect indicator system 198 may be configured to take advantage of diagnostic capabilities already built into the vehicle 100 for detecting defects relating to the in-wheel motors. To this end, the vehicle diagnostics module 147 may be configured to continuously and/or intermittently receive and process information (such as sensor data and/or other information) from vehicle sensors (including wheel-related sensors 123) when the vehicle engine is running.

In a known manner, the vehicle diagnostics module 147 may be configured to analyze and/or otherwise process the sensor information to determine when a vehicle defect (including a defect in any of the in-wheel motors) has occurred. For example, in block 502, the vehicle diagnostics module may determine that a defect exists or is highly likely to occur in an in-wheel motor in one of the road wheels. In block 504, the vehicle diagnostics module 147 may, after a defect is determined to be present or is highly likely to occur, determine a defect code (such as a diagnostic trouble code (DTC)) associated with the in-wheel motor defect. In one or more arrangements, the defect code may be saved in a memory of the vehicle 100 for later access by an OBD (On-Board Diagnostics) scanner in a conventional manner. The vehicle diagnostics module 147 may also be configured to control operation of the vehicle communications interface 169 to transmit the defect code to the light array control module 114, wirelessly or by a wired connection.

In block 506, the vehicle diagnostics module 147 may, simultaneously with determining a defect code associated with the in-wheel motor defect, generate an alert directed to a user and indicating that a wheel defect has been detected.

In block 508, light array control module 114 may determine an appropriate lighting scheme for the defect by determining a lighting scheme saved in local memory 211 that is associated with a received defect code. Any lighting scheme determined to apply to an associated defect may be stored in a buffer in local memory 211 for later access.

FIG. 6 illustrates one example of operation of the visible light array 226 for determining an appropriate lighting scheme and communicating a defect associated with an in-wheel motor of a wheel on which a lighting strip 227 is mounted. In this example, the reference lighting strip 227-1 is aligned with the tire marker 109a as shown in FIG. 4 and is controlled to indicate the wheel defect.

The vehicle diagnostics module 147 may determine that an “excessively high temperature condition” exists in the in-wheel motor. The vehicle diagnostics module 147 may determine that a defect code associated with the defect is “P042”. This defect code may be communicated to the light array control module 114. The light array control module 114 may then (in communication with the defect cross-reference 203) determine that a lighting scheme associated with the defect code “P042” is light source 1 (227-1a) to blue, light source 2 (227-1b) to red, and light source 3 (227-1c) to yellow.

Referring again to FIG. 5, in block 510, the light array control module may control operation of the visible light array so as to display the appropriate lighting scheme stroboscopically while the vehicle wheel is still rotating.

In block 512, the light array control module 114 may, after the wheel 30 stops rotating, and responsive to user instructions to display the appropriate lighting scheme, control operation of the visible light array 226 to implement the appropriate lighting scheme. A user may consult a reference (e.g., a cross-index available by cellular phone) to associate the lighting scheme with the wheel defect.

Referring again to FIG. 5, for situations where the wheel defect is a foreign object lodged in the tire tread as previously described, the light array control module 114 may be configured to process information from the radar sensor 109 to determine when a foreign object is positioned in the tire tread.

In block 514, the radar sensor may detect a foreign object 196 positioned in the tire tread. the light array control module 114 may be configured to (in block 507), responsive to detection of a foreign object 196 in the tire tread, determine a location of the foreign object 196 along the tire tread by determining a position of the foreign object relative to the tire marker 109a. To this end, the light array control module 114 may be configured to receive or acquire information from wheel-related sensors relating to the functions and operations performed by the light array control module. For example, in one or more arrangements, the light array control module 114 may be configured to determine or acquire the rotational speed of the wheel 30 (e.g., in radians/second) using sensor information. The wheel rotation speed may be acquired from a local wheel speed sensor 122 (FIG. 1A). Alternatively, the light array control module 114 may be configured to determine the wheel speed by processing of data from the radar sensor 109.

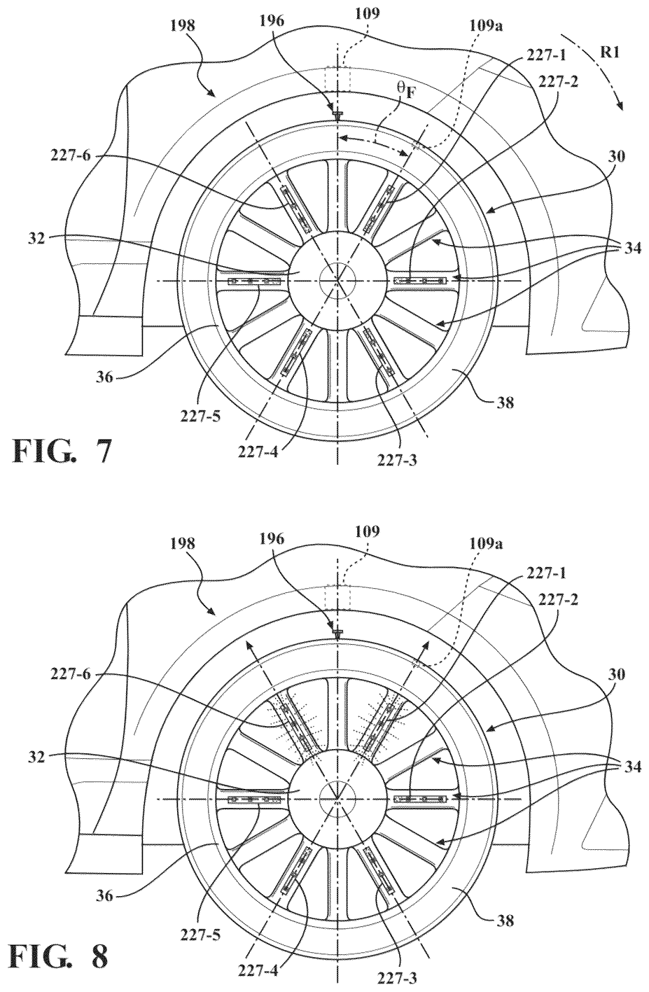

The light array control module 114 may be configured to determine a period of time elapsed between detection of the tire marker 109a and detection of the foreign object 196 when the wheel 30 is rotating in direction R1 (FIG. 7) so as to propel the vehicle 100 in a forward direction. For this purpose, a digital timer (not shown) may be incorporated into (or communicably coupled to) the light array control module 114. The light array control module 114 may be configured to estimate an angular spacing Θ_{F} along the tire tread of the foreign object 196 from the tire marker 109a in a direction opposite the forward tire rotation direction R1 using the rotational speed RSI of the wheel 30 and the elapsed time t1 in accordance with the relationship:

$${⊖}_{F} = RS 1 \times t 1$$

In block 506, the light array control module 114 may, simultaneously with determining a location of the foreign object 196 along the tire tread, generate an alert directed to a user that a wheel defect has been detected.

Referring again to FIG. 5, in block 509, after determining a location of the foreign object 196 along the tire tread, the light array control module 114 may determine a lighting scheme associated with the defect. To this end, the light array control module 114 may be configured to determine which portions of the visible light array 226 are usable to indicate a portion of the tire tread where the foreign object 196 is positioned. This may enable a user to save time by focusing a search for the foreign object 196 along a particular portion of the tire tread. Specifically, referring to FIGS. 7 and 8, with the known angular spacing OF between the foreign object 196 and the tire marker 109a, the information that that the tire marker 109a is aligned with a reference spoke 34 including a lighting strip 227-1, and with the known equal angular spacing between the spokes 34 containing the lighting strips 227, the light array control module 114 may be configured to determine two adjacent lighting strips 227 mounted on either side of the foreign object 196. Thus, in the example shown in FIGS. 7 and 8, the light array control module 114 may determine that the foreign object 196 is positioned along an arc of the tire tread residing between adjacent lighting strips 227-1 and 227-6.

Referring to FIGS. 5 and 8, the light array control module 114 may be configured to (in block 512), after determining a location of the foreign object 196 along the tire tread, and responsive to user instructions to display appropriate lighting scheme, control operation of the visible light array 226 to implement the appropriate lighting scheme. In one or more arrangements, for a foreign object, the lighting scheme may be implemented by activating the two adjacent lighting strips 227-1 and 227-6, to focus the user's search for the foreign object to the tread along the road wheel arc extending between these two lighting strips.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A vehicle wheel defect indicator system comprising:
a visible light array mounted on a vehicle wheel;
a processor; and
a memory communicably coupled to the processor and storing a light array control module including computer-readable instructions that when executed by the processor cause the processor to:
after a defect is detected in the vehicle wheel, determine a lighting scheme associated with the defect; and
control operation of the visible light array to implement the lighting scheme.

2. The vehicle wheel defect indicator system of claim 1, wherein the light array control module includes computer-readable instructions that when executed by the processor cause the processor to:
receive a defect code associated with the defect; and
determine a visible lighting scheme associated with the defect code.

3. The vehicle wheel defect indicator system of claim 1 wherein the visible light array comprises at least one collinear arrangement of light sources structured to be positionable along a spoke of the wheel.

4. The vehicle wheel defect indicator system of claim 3, wherein the visible light array comprises a plurality of angularly-spaced apart collinear light arrangements mounted on an exterior of a side of the vehicle wheel, each light arrangement extending along a line extending radially from a rotational axis of the vehicle wheel.

5. The vehicle wheel defect indicator system of claim 1, wherein the vehicle wheel includes an in-wheel motor incorporated therein.

6. The vehicle wheel defect indicator system of claim 5, wherein the lighting scheme is configured to relate to a defect in the in-wheel motor.

7. The vehicle wheel defect indicator system of claim 1, wherein the lighting scheme is configured to relate to a presence of a foreign object positioned in a tread of a tire of the vehicle wheel.

8. The vehicle wheel defect indicator system of claim 1, wherein the light array control module is stored in a memory mounted on the vehicle wheel.

9. The vehicle wheel defect indicator system of claim 1, wherein the visible light array is structured to be mountable on an exterior of a side of the vehicle wheel.

10. The vehicle wheel defect indicator system of claim 1, further comprising:
a radar reflective element mounted on the vehicle wheel; and
a radar sensor mounted on the vehicle spaced apart from the wheel and configured to detect the radar reflective element during rotation of the vehicle wheel.

11. The vehicle wheel defect indicator system of claim 1, wherein the light array control module includes computer-readable instructions that when executed by the processor cause the processor to control the visible light array so as to display the lighting scheme stroboscopically while the vehicle wheel is rotating.

12. A method of displaying information relating to a defect in a vehicle wheel, the method comprising steps of:
determining that a defect exists in the vehicle wheel;
determining a visible lighting scheme associated with the defect; and
controlling operation of a visible light array to implement the lighting scheme.

13. The method of claim 12, wherein the visible light array is mounted on the vehicle wheel.

14. The method of claim 12, wherein the step of determining a visible lighting scheme associated with the defect comprises steps of:
determining a defect code associated with the defect; and
determining a visible lighting scheme associated with the defect code.

15. The method of claim 14, wherein the defect code is a vehicle diagnostic trouble code (DTC).

16. The method of claim 12, wherein the lighting scheme is configured to relate to a defect in an in-wheel motor of the wheel.

17. The method of claim 12, wherein the lighting scheme is configured to relate to a presence of a foreign object positioned in a tread of a tire of the vehicle wheel.

18. A non-transitory computer readable medium having stored therein instructions, that when executed by a computing system, cause the computing system to perform functions comprising:
determining that a defect exists in a vehicle wheel;
determining a visible lighting scheme associated with the defect; and
controlling operation of a visible light array to implement the lighting scheme.

19. The non-transitory computer readable medium of claim 18, wherein the lighting scheme is configured to relate to a defect in an in-wheel motor of the wheel.

20. The non-transitory computer readable medium of claim 18, wherein the lighting scheme is configured to relate to a presence of a foreign object positioned in a tread of a tire of the vehicle wheel.
